(19) United States
(12) Patent Application Publication
(10) Pub. No.: US 2007/0154775 A1
(43) Pub. Date: Jul. 5, 2007

(54) Anode for direct oxidation fuel cell, and membrane-electrode assembly and direct oxidation fuel cell system including the same

(76) Inventor: In-Hyuk Son, Suwon-si (KR)

Correspondence Address: Robert E. Bushnell, Suite 300, 1522 K Street, N.W., Washington, DC, 20005, US

(21) Appl. No.: 11/647,415

(22) Filed: Dec. 29, 2006

(30) Foreign Application Priority Data
Dec. 30, 2005 (KR) 10-2005-0135165

(51) Int. Cl. H01M 4/86; H01M 4/90; H01M 4/92; H01M 4/96

(52) U.S. Cl. 429/40; 429/44

(57) ABSTRACT

The provided is an anode structure that can be employed in a fuel cell system, and a fuel cell system using the anode structure. The anode structure includes a catalyst-impregnated electrode substrate and a catalyst layer formed on the catalyst-impregnated electrode substrate. The catalyst-impregnated electrode substrate is made by impregnating an electrode substrate with a catalyst. In one embodiment, a catalyst precursor is applied to an electrode substrate, and is heat treated to make an catalyst-impregnated electrode substrate. Experimental results show that power density of a fuel cell system is improved by the use of the anode structure that has a catalyst-impregnated electrode substrate.

### CLAIM OF PRIORITY

This application makes reference to, incorporates the same herein, and claims all benefits accruing under 35 U.S.C. §119 from an application for ANODE FOR DIRECT OXIDATION FUEL CELL, MEMBRANE-ELECTRODE ASSEMBLY AND DIRECT OXIDATION FUEL CELL SYSTEM COMPRISING SAME earlier filed in the Korean Intellectual Property Office on the 30^{th} of December 2005 and there duly assigned Serial No. 10-2005-0135165.

### BACKGROUND OF THE INVENTION

1. Field of the Invention

The present invention relates to an anode for a direct oxidation fuel cell, and a membrane-electrode assembly and a direct oxidation fuel cell system including the same. More particularly, the present invention relates to an anode to improve power characteristics of a direct oxidation fuel cell, and a membrane-electrode assembly and a direct oxidation fuel cell system including the same.

2. Description of the Related Art

A fuel cell is a power generation system for producing electrical energy through an electrochemical redox reaction of an oxidant and hydrogen in a hydrocarbon-based material such as methanol, ethanol, and natural gas.

Such a fuel cell is a clean energy source that can replace fossil fuels. It includes a stack composed of unit cells, and it produces various ranges of power output. Since it has a four to ten times higher energy density than a lithium battery, it has been attracted as a small portable power source.

Types of fuel cells include a polymer electrolyte membrane fuel cell (PEMFC) and a direct oxidation fuel cell (DOFC). The direct oxidation fuel cell includes a direct methanol fuel cell, which uses methanol as a fuel.

The polymer electrolyte fuel cell has an advantage of a high energy density, but it also has problems that it requires careful handling of hydrogen gas and requires accessory facilities such as a fuel reforming processor for reforming methane, methanol, natural gas, and the like in order to produce hydrogen as a fuel gas.

On the contrary, a direct oxidation fuel cell has a lower energy density than the polymer electrolyte fuel cell, but it has advantages of easy handling of a fuel, being capable of operating at room temperature due to its low operation temperature, and no need for additional fuel reforming processors.

### SUMMARY OF THE INVENTION

One embodiment of the present invention provides an anode for improving power density of a direct oxidation fuel cell. Another embodiment of the present invention provides a membrane-electrode assembly including the anode. Yet another embodiment of the present invention provides a direct oxidation fuel cell system including the membrane-electrode assembly.

According to one embodiment of the present invention, an anode for a direct oxidation fuel cell includes a catalyst-impregnated electrode substrate and a catalyst layer formed on a surface of the catalyst-impregnated electrode substrate. The catalyst-impregnated electrode substrate includes an electrode substrate and a catalyst impregnated in the electrode substrate.

The amount of the catalyst is in a range between 0.2 wt % and 20 wt % based on the weight of the catalyst-impregnated electrode substrate.

The catalyst includes platinum, ruthenium, osmium, a platinum-ruthenium alloy, a platinum-osmium alloy, a platinum-palladium alloy, a platinum-M alloy, or combinations thereof, where M is a transition element such as gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), or combinations thereof. The catalyst can be supported on a carrier.

The electrode substrate is formed from a material that includes carbon paper, carbon cloth, carbon felt, metal cloth, or combinations thereof.

According to another embodiment of the present invention, a membrane-electrode assembly for a direct oxidation fuel cell includes a cathode, an anode facing the cathode, and a polymer electrolyte membrane interposed between the anode and the cathode. The anode for a direct oxidation fuel cell includes a catalyst-impregnated electrode substrate and a catalyst layer formed on a surface of the catalyst-impregnated electrode substrate.

According to yet another embodiment of the present invention, a direct oxidation fuel cell system is provided, which includes an electricity generating element for generating electricity by fuel oxidation and oxidant reduction reactions, a fuel supplier for supplying a fuel to the electricity generating element, and an oxidant supplier for supplying an oxidant to the electricity generating element. The electricity generating element includes the membrane-electrode assembly of the another embodiment of the present invention, and a pair of separators. The membrane-electrode assembly is disposed between the pair of separators.

The fuel supplier further supplies carboxylic acid to the electricity generating element along with the fuel. The carboxylic acid includes formic acid, acetic acid, propionic acid, or combinations thereof.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional view showing a membrane-electrode assembly constructed as an embodiment of the present invention.

FIG. 2 is a schematic diagram showing the structure of a fuel cell system constructed as another embodiment of the present invention.

### DETAILED DESCRIPTION OF THE INVENTION

An exemplary embodiment of the present invention will hereinafter be described in detail with reference to the accompanying drawings.

The present invention is drawn to a direct oxidation fuel cell. At an anode of the fuel cell, a hydrocarbon fuel is oxidized to generate protons, and the protons react with an oxidant supplied to a cathode to generate water and electricity.

According to one embodiment of the present invention, an anode includes an electrode substrate that is impregnated with catalysts, in order to increase output characteristics of a direct oxidation fuel cell. The anode, including the catalyst-impregnated electrode substrate, is suitable to be used with a hydrocarbon fuel and carboxylic acid supplied to the anode. The hydrocarbon fuel includes methanol, ethanol, propanol, butanol, or natural gas. In the present specification, the hydrocarbon fuel does not refer to carboxylic acid.

The anode of one embodiment of the present invention includes a catalyst-impregnated electrode substrate and a catalyst layer formed on a surface of the catalyst-impregnated electrode substrate. The catalyst-impregnated electrode substrate includes an electrode substrate that is impregnated with a catalyst. Generally, in a fuel cell, a catalyst layer is disposed by coating an electrode substrate with a composition for a catalyst layer. Since the electrode substrate has pores, a small amount of the composition for a catalyst layer can be permeated into the electrode substrate. However, when the composition for a catalyst layer is permeated into the electrode substrate, an ionomer binder such as perfluorosulfonic acid included in the composition is also permeated into the electrode substrate. The catalyst-impregnated electrode substrate of the present invention is different from the electrode substrate in which the composition for a catalyst layer is naturally permeated by wetting phenomenon. In the catalyst-impregnated electrode substrate of the present invention, a catalyst is intentionally and controllably impregnated into a electrode substrate, and unnecessary element such as ionomer binder is excluded from the impregnation.

In addition, when an electrode substrate is impregnated with only a catalyst, as disclosed in the present invention, the electrode substrate improves power output.

The catalyst impregnated in an electrode substrate is the same as a catalyst of a catalyst layer. Examples of the catalyst are metals such as platinum, ruthenium, osmium, a platinum-ruthenium alloy, a platinum-osmium alloy, a platinum-palladium alloy, a platinum-M alloy, or combinations thereof, where M is a transition element such as gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), or combinations thereof. According to one embodiment, a platinum-ruthenium alloy can be suitable. The metal can be supported on a carrier. The carrier can include carbon such as acetylene black, denka black, carbon black, ketjen black, activated carbon, graphite, or so on, or an inorganic particulate such as alumina, silica, titania, zirconia, or so on.

The amount of the catalyst impregnated in the electrode substrate ranges from 0.2 wt % to 20 wt % based on the weight of the catalyst-impregnated electrode substrate. According to one embodiment, the amount of the catalyst ranges from 1 wt % to 5 wt %. If an electrode substrate is impregnated with the catalyst in an amount less than 0.2 wt %, it may produce little impregnation effects. On the contrary, if the amount is more than 20 wt %, catalyst particles are stuck together forming particles of large size, and also as a result, produce little impregnation effects.

In one embodiment, the electrode substrate is formed from a material such as carbon paper, carbon cloth, carbon felt, or a metal cloth (a porous film composed of metal fiber or a metal film disposed on a surface of a cloth composed of polymer fibers). The material for the electrode substrate is not limited thereto. The electrode substrates of the anode and the cathode support the anode and cathode, respectively, and provide a path for transferring a fuel and an oxidant to the catalyst layer.

The catalyst-impregnated electrode substrate can be treated with a fluorine-based resin to make the substrate water-repellent, which prevents deterioration of diffusion efficiency due to water generated during operation of a fuel cell. The fluorine-based resin can include polyvinylidene fluoride, polytetrafluoroethylene, fluorinated ethylene propylene, polychlorotrifluoroethylene, a fluoroethylene polymer, or combinations thereof, but is not limited thereto.

A microporous layer (MPL) can be added between the catalyst-impregnated electrode substrate and the catalyst layer to increase reactant diffusion effects. The microporous layer generally includes conductive powders having a particular particle size. The conductive material includes, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by applying a composition including a conductive powder, a binder resin, and a solvent to the catalyst-impregnated electrode substrate. The binder resin may include, but is not limited to, polytetrafluoroethylene, polyvinylidene fluoride, polyvinylalcohol, cellulose acetate, and so on. The solvent may include, but is not limited to, an alcohol such as ethanol, isopropyl alcohol, n-propyl alcohol, butanol, and so on, water, dimethyl acetamide, dimethyl sulfoxide, and N-methylpyrrolidone. The coating method may include, but is not limited to, screen printing, spray coating, doctor blade methods, gravure coating, dip coating, silk screening, painting, and so on, depending on the viscosity of the composition.

The anode of one embodiment of the present invention includes a catalyst-impregnated electrode substrate that can have the structure described above, and a catalyst layer disposed on the catalyst-impregnated electrode substrate. The catalyst layer is formed from a material such as platinum, ruthenium, osmium, a platinum-ruthenium alloy, a platinum-osmium alloy, a platinum-palladium alloy, a platinum-M alloy, or combinations thereof, where M is transition elements such as gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), or combinations thereof. Examples of the catalysts include Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, or combinations thereof.

Such a metal catalyst can be used in a form of a metal itself (black catalyst), or can be used in a form of being supported on a carrier. The carrier may include carbon such as acetylene black, denka black, activated carbon, ketjen black, or graphite, or an inorganic particulate such as alumina, silica, zirconia, or titania. Carbon material is generally used for the carrier. A noble metal supported on a carrier is generally available in the market. Alternatively, a noble metal supported on a carrier also can be manufactured by processes that carry a noble metal on a carrier. The process for supporting a noble metal on a carrier is well known to those skilled in the art, so the detailed description will be omitted.

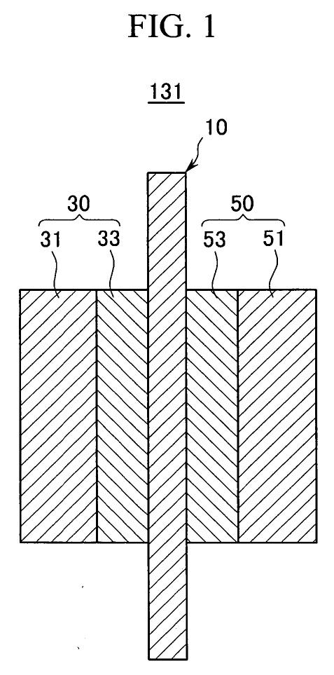

FIG. 1 is a schematic cross-sectional view of a membrane-electrode assembly 131 constructed as an embodiment of the present invention. Hereinafter, membrane-electrode assembly 131 of the present invention is described in more detail referring to FIG. 1. Membrane-electrode assembly 131 includes anode 30 and cathode 50, which face each other, and polymer electrolyte membrane 10 disposed between anode 30 and cathode 50. Anode 30 includes catalyst-impregnated electrode substrate 31 and anode catalyst layer 33 formed on a surface of catalyst-impregnated electrode substrate 31. Cathode 50 includes cathode electrode substrate 51 and cathode catalyst layer 53 formed on cathode electrode substrate 51. Catalyst-impregnated electrode substrate 31 includes an electrode substrate impregnated with a catalyst.

Cathode catalyst layer 53 of cathode 50 includes a metal such as platinum, ruthenium, osmium, platinum-ruthenium alloys, platinum-osmium alloys, platinum-palladium alloys, platinum-M alloys, or combinations thereof, where M is a transition element such as gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), or combinations thereof. The metal can be supported on a carrier, and the same carrier as in the anode can be used in the cathode.

Polymer electrolyte membrane 10 can include any polymer resin having proton conductivity. The polymer resin can have a cation exchange group such as a sulfonic acid group, a carboxylic acid group, a phosphoric acid group, a phosphonic acid group, or derivatives thereof, at its side chain.

Examples of the polymer resin include proton conductive polymers such as fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, or polyphenylquinoxaline-based polymers. In a preferred embodiment, the proton conductive polymer includes poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly (2,5-benzimidazole).

In a proton conductive group of the proton conductive polymer, hydrogen (H) can be replaced with sodium (Na), potassium (K), lithium (Li), cesium (Cs), or tetrabutylammonium. When the hydrogen (H) is replaced with sodium (Na) in an ion exchange group at the terminal end of the proton conductive group, NaOH can be used to induce the replacement. When the hydrogen is replaced with tetrabutylammonium, tetrabutylammonium hydroxide is used. The hydrogen can be replaced with K, Li, or Cs by using appropriate compounds. A method of replacing hydrogen is known in the related art, and therefore is not described in detail.

In the present invention, catalyst-impregnated electrode substrate 31 of anode 30 in membrane-electrode assembly 131 can be made in any method as long as an electrode substrate can be impregnated with a catalyst. More specifically, an electrode substrate included in catalyst-impregnated electrode substrate 31 can be impregnated with a catalyst precursor solution followed by a heat-treatment process.

The catalyst precursor includes H₂PtCl₆.6H₂O, Pt(C₅H₇O₂)₂, or H₆Cl₂N₂Pt. The catalyst precursor also includes a solvent such as water, ethanol, methanol, or isopropyl alcohol.

In addition, the heat treatment can be performed at a temperature ranging from 300° C. to 800° C. for 1 to 3 hours. The heat treatment can also be performed under an atmosphere of hydrogen (H₂) gas, or a mixture of hydrogen (H₂) gas and nitrogen (N₂) gas. The heat treatment transforms a catalyst precursor into a catalyst through a reduction reaction, so that only the catalyst remains on the electrode substrate. If the heat treatment is performed at temperature lower than 300° C., the reduction reaction may not occur. On the other hand, if the heat treatment is performed at temperature higher than 800° C., the electrode substrate can be burnt.

A direct oxidation fuel cell system of the present invention includes an electricity generating element, a fuel supplier, and an oxidant supplier. The electricity generating element includes a membrane-electrode assembly, which has the structure described above, and separators positioned at both sides of the membrane-electrode assembly. The electricity generating element generates electricity through processes of oxidation of fuel and reduction of an oxidant.

The fuel supplier supplies a fuel including hydrogen to the electricity generating element. The fuel includes liquid or gaseous hydrogen, or a hydrocarbon-based fuel such as methanol, ethanol, propanol, butanol, or natural gas. The fuel supplier can further supply carboxylic acid. The carboxylic acid is supplied along with a fuel to the electricity generating element. The carboxylic acid includes formic acid, acetic acid, or propionic acid. According to one embodiment, formic acid may be suitable.

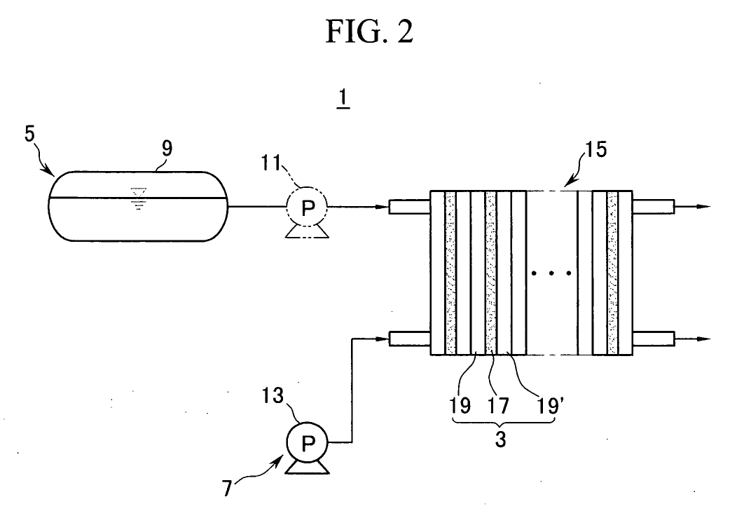

FIG. 2 shows a schematic structure of a fuel cell system 1 that will be described in detail with reference to this accompanying drawing. FIG. 2 shows a fuel cell system, where a fuel and an oxidant are provided to electricity generating element 3 through fuel pumps 11 and oxidant pump 13, respectively. The present invention, however, is not limited to such structures, and other method can be used to supply the fuel and the oxidant. The fuel cell system of the present invention alternatively includes a structure where a fuel and an oxidant are provided in a diffusion manner.

Fuel cell system 1 includes at least one electricity generating element 3 that generates electrical energy through an electrochemical reaction of a fuel and an oxidant, fuel supplier 5 for supplying a fuel to electricity generating element 3, and oxidant supplier 7 for supplying an oxidant to electricity generating element 3. In addition, fuel supplier 5 is equipped with tank 9, which stores a fuel, and fuel pump 11, which is connected to tank 9. Fuel pump 11 supplies the fuel stored in tank 9 to electricity generating element 3 with a predetermined pumping power. Oxidant supplier 7, which supplies an oxidant to electricity generating element 3, is equipped with at least one oxidant pump 13 for supplying an oxidant to electricity generating element 3 with a predetermined pumping power.

Electricity generating element 3 includes membrane-electrode assembly 17 that oxidizes hydrogen or a fuel and reduces an oxidant, and separators 19 and 19′ that are positioned at both opposite sides of membrane-electrode assembly 17. Separators 19 and 19′ supply hydrogen or a fuel, and an oxidant to membrane-electrode assembly 17. At least one electricity generating element 3 is included in stack 15, as described above, membrane-electrode assembly 17 of fuel cell system 1 of the present invention include an electrode substrate that is impregnated with catalyst.

The following examples illustrate the present invention in more detail. However, it is understood that the present invention is not limited by these examples.

### EXAMPLE 1

H₂PtCl₆.6H₂O was dissolved in a solvent of water, preparing a Pt precursor solution. A carbon cloth (made by E-TeK Co.), which was an electrode substrate, was impregnated with the Pt precursor solution, and then reacted for one hour at 500° C. under a reduction atmosphere to make a catalyst-impregnated electrode substrate, which was impregnated with Pt. Herein, the Pt was impregnated in an amount of 0.2 wt % based on the weight of the catalyst-impregnated electrode substrate.

Then, a catalyst composition for an anode was made by mixing 88 wt % of Pt—Ru black (Johnson Matthey) catalyst and 12 wt % of a binder. The binder includes 12 wt % of Nafion/H₂O/2-propanol (Solution Technology Inc.). The catalyst-impregnated electrode substrate, which was impregnated with Pt, was coated with the catalyst composition for an anode to make an anode. Herein, the catalyst composition for an anode was loaded on the catalyst-impregnated electrode substrate in an amount of 5 mg/cm².

A catalyst composition for a cathode was prepared by mixing 88 wt % of Pt black (Johnson Matthey) catalyst and 12 wt % of a binder. The binder includes 5 wt % of Nafion/H₂O/2-propanol (Solution Technology Inc.). The catalyst composition for a cathode was applied to a carbon paper (SGL GDL 10DA), which is a cathode electrode substrate, to make a cathode. Herein, the catalyst composition for a cathode was loaded on the cathode electrode substrate in an amount of 5 mg/cm².

A commercially-available Nafion 115 (perfluorosulfonate) polymer electrolyte membrane is disposed between the anode and cathode to fabricate a unit cell.

### COMPARATIVE EXAMPLE 1

Another unit cell was prepared by the same method described in Example 1, except that an electrode substrate, which was not impregnated with Pt, was used in the another unit cell.

The unit cells of Example 1 and Comparative Example 1 were used to make stacks, and were then supplied with 1M of methanol and 1M of formic acid. The unit cells were, then, operated. Power densities of the fuel cells were measured at temperature of 30° C. and 50° C. at output voltages of 0.45 V, 0.4 V, and 0.35 V. The results of power densities of the unit cells are provided in Table 1.

TABLE 1

| Power density | | 30° C. | | | 50° C. | | |
|---|---|---|---|---|---|---|---|
| mW/cm² | Fuel | 0.45 V | 0.40 V | 0.35 V | 0.45 V | 0.40 V | 0.35 V |
| Comp. Ex. 1 | 1M methanol | 28 | 35 | 38 | 54 | 62 | 64 |
| Ex. 1 | | 30 | 38 | 45 | 58 | 70 | 91 |
| Comp. Ex. 1 | 0.1M formic | 25 | 42 | 53 | 56 | 74 | 91 |
| Ex. 1 | acid and 1M methanol | 28 | 48 | 65 | 60 | 80 | 102 |

As shown in Table 1, the fuel cell of Example 1, which has a catalyst-impregnated electrode substrate, shows improved power density compared to the fuel cell of Comparative Example 1, which has an electrode substrate not impregnated with a catalyst. The improvement is more distinguishable in high temperature. The experimental results proves that an anode for a fuel cell of the present invention, which has an electrode substrate impregnated with a catalyst, produces higher power when the anode is used in a fuel cell system.

While this invention has been described in practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An anode for direct oxidation fuel cell, comprising:
a catalyst-impregnated electrode substrate comprising:
an electrode substrate; and
a catalyst impregnated in the electrode substrate; and
a catalyst layer formed on a surface of the catalyst-impregnated electrode substrate.

2. The anode of claim 1, comprised of the catalyst being selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), and combinations thereof.

3. The anode of claim 1, comprised of the catalyst supported on a carrier.

4. The anode of claim 1, comprised of the amount of the catalyst ranging from 0.2 wt % to 20 wt % based on the weight of the catalyst-impregnated electrode substrate.

5. The anode of claim 4, comprised of the amount of the catalyst being in a range between 1 wt % and 5 wt % based on the weight of the catalyst-impregnated electrode substrate.

6. The anode of claim 1, comprised of the electrode substrate formed from a material selected from the group consisting of carbon paper, carbon cloth, carbon felt, metal cloth, and combinations thereof.

7. A membrane-electrode assembly for a direct oxidation fuel cell, comprising:
a cathode;
an anode facing the cathode, the anode comprising:
a catalyst-impregnated electrode substrate comprising:
an electrode substrate; and
a catalyst impregnated in the electrode substrate; and
a catalyst layer formed on a surface of the catalyst-impregnated electrode substrate; and
a polymer electrolyte membrane interposed between the anode and the cathode.

8. The membrane-electrode assembly of claim 7, comprised of the catalyst being selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), and combinations thereof.

9. The membrane-electrode assembly of claim 7, comprised of the amount of the catalyst ranging from 0.2 wt % to 20 wt % based on the weight of the catalyst-impregnated electrode substrate.

10. The membrane-electrode assembly of claim 9, comprised of the amount of the catalyst being in a range between 1 wt % and 5 wt % based on the weight of the catalyst-impregnated electrode substrate.

11. The membrane-electrode assembly of claim 7, comprised of the electrode substrate formed from a material selected from the group consisting of carbon paper, carbon cloth, carbon felt, metal cloth, and combinations thereof.

12. A direct oxidation fuel cell system comprising:
an electricity generating element for generating electricity by fuel oxidation and oxidant reduction reactions, comprising:
a membrane-electrode assembly comprising:
a cathode;
an anode facing the cathode, the anode comprising:
a catalyst-impregnated electrode substrate including an electrode substrate and a catalyst impregnated in the electrode substrate; and
a catalyst layer formed on a surface of the catalyst-impregnated electrode substrate; and
a polymer electrolyte membrane interposed between the anode and the cathode; and
a pair of separators, the membrane-electrode assembly disposed between the pair of separators;
a fuel supplier for supplying a fuel to the electricity generating element; and
an oxidant supplier for supplying an oxidant to the electricity generating element.

13. The direct oxidation fuel cell system of claim 12, comprised of the catalyst being selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), ruthenium (Ru), and combinations thereof.

14. The direct oxidation fuel cell system of claim 12, comprised of the amount of the catalyst ranging from 0.2 wt % to 20 wt % based on the weight of the catalyst-impregnated electrode substrate.

15. The direct oxidation fuel cell system of claim 14, comprised of the amount of the catalyst being in a range between 1 wt % and 5 wt % based on the weight of the catalyst-impregnated electrode substrate.

16. The direct oxidation fuel cell system of claim 12, comprised of the electrode substrate formed from a material selected from the group consisting of carbon paper, carbon cloth, carbon felt, metal cloth, and combinations thereof.

17. The direct oxidation fuel cell system of claim 12, comprised of the fuel including a hydrocarbon fuel.

18. The direct oxidation fuel cell system of claim 12, comprised of the fuel supplier supplying a carboxylic acid to the electricity generating element along with the fuel.

19. The direct oxidation fuel cell system of claim 18, comprised of the carboxylic acid being a material selected from the group consisting of formic acid, acetic acid, propionic acid, and combinations thereof.
